(19) United States
(12) Patent Application Publication
(10) Pub. No.: US 2012/0059081 A1
(43) Pub. Date: Mar. 8, 2012

(54) RESINS COMPRISING ACRYLATE GROUPS

(76) Inventors: Stefan Busch, Dusseldorf (DE); Juergen Baro, Esslingen (DE); Laurence Druene, Perthes en Gatinais (FR); Jean-Marc Ballin, Noisy le Grand (FR)

(21) Appl. No.: 13/320,336

(22) PCT Filed: Apr. 30, 2010
(86) PCT No.: PCT/EP2010/002648

§ 371 Date: Nov. 14, 2011

(30) Foreign Application Priority Data
May 12, 2009 (EP) 09290351

(51) Int. Cl. C09D 177/06; C09D 11/10; C08J 3/28; C08G 69/48

(52) U.S. Cl. 522/164; 525/426; 525/420.5

(57) ABSTRACT

The invention relates to resins comprising acrylate groups that are liquid at 25° C., obtained in that polycarboxylic acids (a) comprising at least 2 carboxyl groups and at least 2 C atoms per molecule are converted in a first stage with polyamines (b) comprising at least 2 amino groups and at least 2 C atoms per molecule, such that an intermediate compound (z) results, said compound being terminated by carboxyl groups, and said compound (z) being functionalized in a second stage, such that the free carboxyl groups thereof are provided with one or more (meth)acrylate groups in one or more stages, said resins being suitable as radiation-curing compounds for producing coatings.

### FIELD OF THE INVENTION

The invention concerns specific resins comprising acrylate groups which are fluid at 25° C., their synthesis and their use for radiation-curable coatings.

### BACKGROUND ART

EP-B-1,828,273 describes radiation-curable acrylate-modified aminoamide resins. It concerns Michael addition products of (a) thermoplastic aminoamide polymers, derivable from polymerizable unsaturated fatty acids (for example dimeric fatty acids) and (b) polyol esters containing at least three (meth)acrylate ester groups per molecule, wherein the thermoplastic aminoamide polymer (a) has an amine number in the range of 40-60 mg KOH/g and the ratio of the functional (meth)acrylate groups of the polyolesters (b) to the initial functional amine groups of the aminoamide polymers a) is at least 4:1, and the resin is fluid at 25° C. These resins, structurally considered “special acrylated polyamidoamines” (APAA) (this term is used hereinbelow) are used as radiation-curable ingredients in printing inks and lacquers.

The synthesis of the special APAAs is performed in accordance with patent publication EP-B-1,828,273 by condensation of dimer fatty acids with appropriate diamines, for example piperazine, and subsequent chemical conversion of the polyamidoamides obtained therefrom with polyol acrylates like glycerine-3-8PO-triacrylate (GPTA) in a Michael addition. To avoid cross-linking reactions, the polyolacrylate is always applied in a large excess; at the same time, the viscosity of the obtained product is lowered as far as required in the printing ink formulation. The polyolacrylate quasi functions here as reactive diluent.

The term “Michael addition” refers to the addition reaction of an amine group and an activated C═C double bond (typically of an ester). Formally, this may be expressed by the following chemical equation:

NH+C═C—C(O)→NC—CH—C(O)

Such reactions generally shift to the right spontaneously with moderate heating. However, catalysts may be used to accelerate the Michael addition. Although, strictly speaking, this type of reaction would be better described as a Michael-analogous reaction, the more convenient term “Michael addition” used in the patent literature cited above is retained here.

WO 07/030643 A1 (Sun Chemical) employs Michael-adducts of polyolester acrylates and polyaminoamides for use in printing inks, wherein the polyaminoamide is the reaction product of a polyamine and an acid component, provided that this acid component comprises two compulsory constituents, namely (a) a polymerized unsaturated fatty acid (for example a dimer fatty acid) and (b) a fatty acid containing 2-22 C-atoms. Therefore, it appears that an important characteristic disclosed in W02007/030643 is that the synthesis of an APAA-resin is performed while adding a monocarboxylic acid. Compared to conventional printing inks, the product ultimately obtained would lead less ink misting during printing.

### DETAILED DESCRIPTION OF THE INVENTION

Radiation-curable acrylated polyamidoamines (APAAs) on the one hand have a certain tradition, while on the other hand, there is a continuing demand for improvements. In this context, it was an object of the present invention to provide new radiation-curable resins that are fluid at 25° C., and that comprise (meth)acrylate groups. These resins should generally be suitable for coating purposes and particularly for printing inks, preferably offset printing inks.

A disadvantage of the state-of-the-art methods described above is that the reactive diluent being used must be identical to the acrylate that is used in the synthesis of the APAAs. Hence, for example, the synthesis of a GPTA-end-capped APAAs in TMP+3PO-triacrylate (TMPPOTA) is not possible.

In this context, a further object of the present invention was to provide a method that allows synthesis of radiation-curable resins that are at 25° C. and comprise (meth)acrylate groups, using any diluent, in particular a reactive diluent.

The present invention is directed to resins being fluid at 25° C., comprising acrylates groups, obtainable by chemically converting, in a first step, polycarboxylic acids (a), containing at least 2 carboxyl groups and at least 2 C-atoms per molecule using polyamines (b) that contain at least 2 amine groups and at least two 2 C-atoms per molecule, in such a way that an intermediate component (z) is formed which is end-capped by carboxyl groups. In a second step, this intermediate component is functionalized in such a way that its free carboxyl groups are in one ore more steps provided with one or more (meth)acrylate groups.

The expression “acrylate groups” in the context of the present invention is meant to encompass both acrylate groups and methacrylate groups and is used in the interest of brevity.

For the sake of clarity, it is emphasized that there is a structural difference between the state-of-the-art resins described above (the APPAs) and the resins according to the present invention. The present resins according to the present invention and those known in the art have the following properties in common: the resin is a polymer, it contains polycarboxylic acids (particularly dimer fatty acids) and polyamines (particularly piperazine) as basic building blocks, and the resin distinguishes itself by being end-capped with acrylate groups. Nevertheless, there are also fundamental differences: according to the state of the art referred to above, a resin is synthesized by a first step in which a polyamidoamine is synthesized by chemical conversion of polycarboxylic acids and polyamines, which in nature is end-capped with amine groups, and a further building block is coupled via Michael addition (addition of NH to C═C) to this polyamidoamine. However, according to the present invention, the first step, i.e., the conversion of polycarboxylic acid and polyamine, is performed such that an intermediate component, end-capped with carboxyl groups, is formed, and this intermediate component is then functionalized so that its free carboxyl groups are, in one or ore steps, provided with one or more (meth)acrylate groups.

Polycarboxylic Acids (a)

The polycarboxylic acids (a) contain at least 2 carboxyl groups and at least 2 C-atoms per molecule, The polycarboxylic acids (a) are preferably dicarboxylic acids containing 2 to 54 C-atoms per molecule.

In one embodiment, the dicarboxylic acids are selected from the group consisting of dimer fatty acids, aliphatic α,ω-dicarboxylic acids containing 2 to 22 C-atoms, and two-basic aromatic carboxylic acids containing 8 to 22 C-atoms.

Preferably, the dicarboxylic acids being used are dimer fatty acids. As is commonly known to the expert, dimer fatty acids are carboxylic acids which are obtainable by oligomerizing unsaturated carboxylic acids, generally fatty acids such as oleic acid, linoleic acid, erucic acid and the like. The oligomerization generally takes place at elevated temperature in the presence of a catalyst, for example of clay.

The substances obtained—technical-quality dimer fatty acids—are mixtures in which the dimerization products predominate. However, the mixtures also contain small amounts of monomers (the sum of monomers in the crude mixture of the dimers is referred to by experts in the field as “monomer fatty acids”) and higher oligomers, more especially so-called trimer fatty acids. Dimer fatty acids are commercially available products in various compositions and qualities (for example under the name Empol®, a product of applicants).

In one embodiment, the dicarboxylic acids used are am-dicarboxylic acids containing 2 to 22 C-atoms, more particularly saturated dicarboxylic acids of this type. Examples include ethane dicarboxylic acid (oxalic acid), propane dicarboxylic acid (malonic acid), butane dicarboxylic acid (succinic acid), pentane dicarboxylic acid (glutaric acid), hexane dicarboxylic acid (adipic acid), heptane dicarboxylic acid (pimelic acid), octane dicarboxylic acid (suberic acid), nonane dicarboxylic acid (azelaic acid), decane dicarboxylic acid (sebacic acid), undecane dicarboxylic acid, dodecane dicarboxylic acid, tridecane dicarboxylic acid (brassylic acid), tetradecane dicarboxylic acid, pentadecane dicarboxylic acid, hexadecane dicarboxylic acid (thapsic acid), heptadecane dicarboxylic acid, octadecane dicarboxylic acid, nonadecane dicarboxylic acid, eicosane dicarboxylic acid.

In one embodiment, the dicarboxylic acids used are dibasic aromatic carboxylic acids containing 8 to 22 carbon atoms, for example isopthalic acid.

Certain embodiments are mixtures of various dicarboxylic acids, for example dimer fatty acids in admixture with at least one acid from the group of α,ω-dicarboxylic acids containing 2 to 22 carbon atoms.

Polyamines (b)

The polyamines (b) contain at least 2 amine groups and at least 2 C-atoms per molecule. The polyamines (b) preferably are diamines containing 2 to 36 C-atoms per molecule. Examples of suitable diamines are ethylene diamine, hexamethylene diamine, diaminopropane, piperazine, aminoethyl piperazine, 4,4′-dipiperidine, toluene diamine, methylene dianiline, xylene diamine, methyl pentamethylene diamine, diaminocyclohexane, polyether diamine and diamines produced from dimer acid.

The diamines are preferably selected from the group consisting of ethylene diamine, hexamethylene diamine, diaminopropane, piperazine and aminoethyl piperazine. Piperazine and aminoethyl piperazine are most preferred.

In another embodiment, mixtures of different diamines are used.

Intermediate Component (z)

As already mentioned, the intermediate component (z), which results from chemical conversion of the polycarboxylic acids (a) with the polyamines (b), is characterized in that it is end-capped with carboxyl groups. Accordingly, the intermediate components (z) can also be characterized as polyamides end-capped with carboxyl groups. The way the polycarboxylic acids (a) are chemically converted with the polyamines (b), to form a carboxyl-group end-capped intermediate component (z), is not to considered limited in any way. Consequently, every technical measure which causes the intermediate product (z) to be end-capped with carboxyl groups is included. For example, this can be realized by controlling the ratio of the extent of conversion of reactants (a) and (b).

If desired, the chemical conversion of the polycarboxylic acids (a) with the polyamines (b) to the intermediate components (z) can be performed in the presence of a diluent or reactive diluent, provided that the diluents or reactive diluents do not comprise free hydroxyl, carboxyl and/or amine groups.

Provided that a dimer fatty acid is used as dicarboxylic acid (a), chemical conversion with diamines (b) results in a polyamide (z), which could be referred to as a polyamidodimerate, that is end-capped with carboxyl groups. Compared to the polyamidoamine synthesis known in the art and referred to above, a deficiency of diamine (b) additionally enables a simplified reaction, since no diamine is lost by sublimation during the condensation. Furthermore, addition of water, in order to lead the sublimated diamines back to the reaction chamber, is omitted. Thus, it must not be removed again during the course of the condensation.

Optionally, a monofunctional acid, particularly a monocarboxylic acid containing 6 to 12 C-atoms, can be used with the chemical conversion of polycarboxylic acid (particularly dicarboxylic acids and more particularly dimer fatty acids) (a) and polyamine (particularly diamine and more particularly piperazine) (b) in order to influence the functionality and the molecular weight of the resulting intermediate product (z). Preferably, the amount of monocarboxylic acid used is in the range of 1% to 25% of the acid groups, based on the total number of acid groups of the dicarboxylic acids and monocarboxylic acids.

Transfer of the Intermediate Component (z) Into the Acrylated Resin

As already stated, the intermediate component (z) which is end-capped with carboxyl groups is finally functionalized such that its free carboxyl groups are, in one or more steps provided with one or more acrylate groups. Acrylate groups as specified above encompass both acrylate and methacrylate groups.

This implies that the free carboxyl groups of the intermediate component (z) are completely or predominantly functionalized such that, per functionalized carboxyl function, one or more acrylate groups result. Two exemplary routes for this functionalization are given:

In one embodiment, the intermediate components (z) are chemically converted with hydroxy-functional polyolacrylates, containing at least one free OH-group and at least one acrylate group per molecule. Hydroxy-functional polyolacrylates (hydroxypolyolacrylate) as referred to herein are esters which result from chemical conversion of polyols (it is particularly stated that instead of polyols, their adducts with ethylene and/or propylene oxide can be used) with acrylic or methacrylic acid, provided that the chemical conversion is conducted such that the resulting products have at least one free hydroxyl group per molecule.

Suitable hydroxy-functional polyolacrylates are, for example, pentaerythritol triacrylate (PETIA), pentaerythritol+5EO-triacrylate (triacrylate of an adduct of 5 moles of ethylene oxide and 1 mole of pentaerythritol) or dipentaerythritol pentaacrylate. Mixtures of different hydroxypolyol acrylates can be used as well.

In a further embodiment, the intermediate components (z) are first chemically converted with a dialkanolamine, more in particular a diethanolamine (NH[CH₂—CH₂—OH]₂), in the sense of an amidification, in which the carboxyl groups of the intermediate components (z) react with the amine groups, resulting in an intermediate component (z*) which is end-capped with hydroxyl groups. Subsequently, this component (z*) is esterified by chemical conversion with acrylic or methacrylic acid.

In a further embodiment, the intermediate components (z) are first chemically converted with a polyol which contains at least 2 OH-groups per molecule, preferably three or more OH-groups, such that only one OH-group per molecule reacts, resulting in an intermediate component (z**) which is end-capped with hydroxyl groups. Subsequently, this component (z**) is esterified by chemical conversion with acrylic or methacrylic acid.

If desired the conversion of the intermediate component (z) into the acrylated resin can be performed in the presence of a diluent or reactive diluent.

A further aspect of the present invention is radiation-curable coating compositions containing a cross-linkable component and a photoinitiator, wherein the cross-linkable component contains at least one acrylated resin according to the present invention. All the foregoing embodiments apply in regard to the acrylated resin. In a preferred embodiment, the compositions additionally contain a pigment and hence are printing inks; preferably these compositions are used in offset printing.

A further aspect of the present invention is a method for synthesizing the resins of the invention, wherein, in a first step polycarboxylic acids (a), containing at least 2 carboxyl groups and at least 2 C-atoms per molecule, are chemically converted with polyamines (b), containing at least 2 amine groups and at least 2 C-atoms per molecule, such that an intermediate component (z) is formed which is end-capped by carboxyl groups. This intermediate component (z) is functionalized in a second step such that its free carboxyl groups are in one or more steps provided with one or more (meth)acrylates groups. In one embodiment, the first and/or second steps are preformed in the presence of a diluent or reactive diluent, provided that the diluent or reactive diluents, if used in the first step, are free of hydroxyl, carboxyl and/or amine groups. In another embodiment, the first step of the method is performed in the presence of a monocarboxylic acid containing 6 to 12 C-atoms.

### EXAMPLES

### Example 1

### Synthesis of an Intermediate Component (z) End-Capped with Carboxyl Groups

188,00 g (0.34 mol) of dimer fatty acid (Pripol 1013, Croda) was introduced in a 0.5 liter four-necked flask, equipped with a stirrer and a reflux condenser, heated to 80° C. under a nitrogen atmosphere, and 21.28 g (0.25 mol) piperazine was added. The reaction mixture was heated to a temperature of 140° C. within 2 hours. After 30 minutes, the reflux condenser was exchanged with a distillation bridge, and the reaction water was distilled off under slow heating (within 2 hours) to 205° C. and finally stirred at 205-210° C. until the amine number had fallen under 2 mg KOH/g. The polyamidodimerate obtained was highly viscous at room temperature and had a bright brown color.

The following characteristics were determined: acid number=44.9 mg KOH/g, amine number: 0.7 mg KOH/g, difference=44.2 mg KOH/g.

### Example 2

### Conversion of the Polyamidodimerates from Example 1 to a Resin

The conversion of the polyamidodimerates if Example 1 to a resin of the present invention can, as described above, be performed using various methods. An exemplary preparation method is described.

100 g polyamidodimerate, according to Example 1, and 41 g pentaerythritol+5EO-triacrylate (triacrylate of an adduct of 5 moles of ethylene oxide and 1 mole of pentaerythritol) were first esterified in the presence of 2 g methane sulfonic acid and 150 mg MeHQ at atmospheric pressure and 90° C. During the full course of the reaction, air was forced through the reaction solution. Once ongoing distillation barely resulted in additional reaction water, a vacuum was applied and distillation was performed until the acid number had fallen under 5 mg KOH/g.

1. A resin comprising acrylate groups that is fluid at 25° C., produced by the steps of:
(a) chemically converting polycarboxylic acids comprising at least 2 carboxyl groups and at least 2 C-atoms per molecule, with polyamines comprising at least 2 amine groups and at least 2 C-atoms per molecule, forming an intermediate (z) which is end-capped with carboxyl groups, and
(b) functionalizing the intermediate such that its free carboxyl groups are esterified with one or more (meth)acrylates groups in one or more steps.

2. The resin according to claim 1, wherein the polycarboxylic acids are dimer fatty acids.

3. The resin according to claim 1, wherein the polyamines are selected from the group consisting of ethylenediamine, hexamethylenediamine, diaminopropane, piperazine and aminoethylpiperazine.

4. A method for synthesizing resin comprising acrylate groups that is fluid at 25° C., comprising:
(a) chemically converting polycarboxylic acids comprising at least 2 carboxyl groups and at least 2 C-atoms per molecule, with polyamines comprising at least 2 amine groups and at least 2 C-atoms per molecule, to form an intermediate, which is end-capped with carboxyl-groups, and
(b) functionalizing the intermediate such that its free carboxyl groups are esterified with one or more (meth)acrylate groups in one or more steps.

5. The method according to claim 4, wherein step (a) and/or step (b) is performed in the presence of a diluent or reactive diluent, wherein, when the diluent or reactive diluent is present in step (a), it is free of hydroxyl groups.

6. The method according to claim 4, wherein step (a) is performed in the presence of a monocarboxylic acid comprising 6 to 12 C-atoms.

7. A radiation-curable coating composition comprising a cross-linkable component and a photoinitiator, which cross-linkable component comprises at least one resin according to claim 1.

8. The composition according to claim 7, additionally comprising a pigment, which is a printing ink.

9. (canceled)

10. The method according to claim 5, wherein step (a) is performed in the presence of a monocarboxylic acid comprising 6 to 12 C-atoms.

11. A radiation-curable coating composition comprising a cross-linkable component and a photoinitiator, which cross-linkable component comprises at least one resin according to claim 2.

12. A radiation-curable coating composition comprising a cross-linkable component and a photoinitiator, which cross-linkable component comprises at least one resin according to claim 3.

13. A radiation-curable coating composition comprising a cross-linkable component and a photoinitiator, which cross-linkable component comprises at least one resin made by the method according to claim 4.
